(19) United States
(12) Patent Application Publication
(10) Pub. No.: US 2020/0358071 A1
(43) Pub. Date: Nov. 12, 2020

(54) ENERGY STORAGE DEVICE AND METHOD OF MANUFACTURING ENERGY STORAGE DEVICE

(71) Applicant: GS Yuasa Internationl Ltd., Kyoto-shi (JP)

(72) Inventor: Hironori KAWANISHI, Kyoto-shi, Kyoto (JP)

(21) Appl. No.: 16/640,659

(22) PCT Filed: Oct. 12, 2018
(86) PCT No.: PCT/EP2018/077904

§ 371 Date: Feb. 20, 2020

(30) Foreign Application Priority Data
Oct. 12, 2017 (JP) 2017-198818

(51) Int. Cl. H01M 2/30; H01M 2/04

(52) U.S. Cl. CPC H01M 2/305; H01M 2/0434

(57) ABSTRACT

An energy storage device includes: an outer case on which an external terminal is mounted; an electrode assembly housed in the outer case; a conductive shaft portion formed using a material different from a material for forming the external terminal, and having a swaged portion connected to the external terminal on one end thereof in an axial direction; a conductive plate portion housed in the outer case, to which the other end of the conductive shaft portion is connected, and the electrode assembly is connected; and a metal plate disposed between the external terminal and the swaged portion in the axial direction of the conductive shaft portion.

### TECHNICAL FIELD

The present invention relates to an energy storage device which includes an external terminal, and a method of manufacturing an energy storage device.

### BACKGROUND ART

A chargeable and dischargeable energy storage device is used in various equipment such as a mobile phone and an automobile. A vehicle which uses electric energy as a power source such as an electric vehicle (EV) or a plug-in hybrid electric vehicle (PHEV) requires large energy. Accordingly, an energy storage module of a large capacity which includes a plurality of energy storage devices is mounted on the vehicle.

In general, an energy storage device is configured such that an electrode assembly formed by stacking or winding a positive electrode plate and a negative electrode plate with a separator interposed between the positive electrode plate and the negative electrode plate is gas-tightly housed in a case together with an electrolyte solution. A positive electrode external terminal and a negative electrode external terminal electrically connected to the electrode assembly via current collectors are mounted on a lid plate of the case.

A gasket or an insulation plate is disposed between the case and the terminal and between the case and the current collector.

Patent document 1 discloses a lithium ion secondary battery having a prismatic case. Through holes are formed in the lid of the case. A rod like barrel portion is inserted into the through hole, one end portion of the barrel portion is connected to a first flange portion in the case and the other end portion of the barrel portion is connected to a terminal plate (external terminal). A tab of the electrode assembly is connected to the first flange portion.

### PRIOR ART DOCUMENT

### Patent Document

Patent Document 1: JP-A-2016-91659

### SUMMARY OF THE INVENTION

### Problems to be Solved by the Invention

Such an energy storage device is requested to exhibit favorable mechanical and electrical connecting properties between the external terminal and the current collector, favorable gas-tightness and favorable property of preventing a leakage of a liquid from the energy storage device and intrusion of moisture into the energy storage device.

The present invention has been made in view of such circumstances, and it is an object of the present invention to provide an energy storage device which exhibits favorable gas-tightness and can prevent a leakage of a liquid from the energy storage device and intrusion of moisture into the energy storage device, and a method of manufacturing such an energy storage device.

### Means for Solving the Problems

An energy storage device according to an aspect of the present invention includes: an outer case on which an external terminal is mounted; an electrode assembly housed in the outer case; a conductive shaft portion formed using a material different from a material for forming the external terminal, and having a swaged portion connected to the external terminal on one end thereof in an axial direction; a conductive plate portion housed in the outer case, to which the other end of the conductive shaft portion is connected, and the electrode assembly is connected; and a metal plate disposed between the external terminal and the swaged portion in the axial direction of the conductive shaft portion.

A method of manufacturing an energy storage device according to another aspect of the present invention includes the steps of: disposing an external terminal having a second through hole on an outer surface of a lid plate having a first through hole; disposing a metal plate having a third through hole on the external terminal; inserting a conductive shaft portion into the first, the second and the third through holes; and swaging a distal end of the conductive shaft portion such that the metal plate is disposed between the external terminal and a swaged portion in an axial direction of the conductive shaft portion.

### Advantages of the Invention

According to the aspects of the present invention, the metal plate is interposed between one end (distal end) of the conductive shaft portion and the external terminal. Accordingly, in swaging one end of the conductive shaft portion to the external terminal, a pressing force generated by swaging is dispersed through the metal plate. Since the deformation of the external terminal can be suppressed, one end of the conductive shaft portion can be swaged with a strong force so that it is possible to acquire favorable mechanical and electrical connecting properties between the swaged portion and the external terminal. Accordingly, the energy storage device exhibits favorable gas-tightness and prevents a leakage of a liquid from the energy storage device and the intrusion of moisture into the energy storage device.

### BRIEF DESCRIPTION OF THE DRAWINGS

FIG. 1 is a perspective view of an energy storage device according to a first embodiment.

FIG. 2 is a front view of the energy storage device.

FIG. 3 is a cross-sectional view taken along line III-III in FIG. 2.

FIG. 4 is a partially enlarged cross-sectional view taken along line IV-IV in FIG. 2.

FIG. 5 is a microscope photograph showing a cross section of a swaged portion in a state where the swaged portion is formed by swaging a conductive shaft portion to a negative electrode terminal without placing a washer on a bottom surface of a recessed portion.

FIG. 6 is a microscope photograph showing a cross section of a swaged portion in a state where the swaged portion is formed by swaging a conductive shaft portion to a negative electrode terminal in a state where a washer is placed on the bottom surface of the recessed portion.

FIG. 7 is a cross-sectional view showing a portion of a negative electrode terminal on which a lid plate is mounted in an energy storage device according to a second embodiment.

### MODES FOR CARRYING OUT THE INVENTION

### Summary of the Embodiment

An energy storage device of this embodiment includes: an outer case on which an external terminal is mounted; an electrode assembly housed in the outer case; a conductive shaft portion formed using a material different from a material for forming the external terminal, and having a swaged portion connected to the external terminal on one end thereof in an axial direction; a conductive plate portion housed in the outer case, to which the other end of the conductive shaft portion is connected, and the electrode assembly is connected; and a metal plate disposed between the external terminal and the swaged portion in the axial direction of the conductive shaft portion.

There is a case where a material for forming the conductive shaft portion and a material for forming the external terminal differ from each other. For example, the conductive shaft portion is harder than the external terminal. In such a case, when one end of the conductive shaft portion is swaged to the external terminal, the external terminal is liable to be deformed. In the above-mentioned configuration, the metal plate is interposed between one end of the conductive shaft portion and the external terminal and hence, when one end of the conductive shaft portion is swaged to the external terminal, a pressing force generated by swaging is dispersed through the metal plate. Since the deformation of the external terminal is suppressed and swaging can be performed with a strong force, it is possible to acquire favorable mechanical and electrical connecting properties between the swaged portion and the external terminal. The swaged portion, the external terminal, a lid plate, and the conductive plate portion are favorably integrated and hence, it is possible to provide the energy storage device which exhibits favorable gas-tightness, can prevent leakage of a liquid from the energy storage device, and can prevent the intrusion of moisture into the energy storage device.

The conductive plate portion is formed in a plate shape extending substantially parallel to the lid plate of the outer case, having a first surface to which the other end of the conductive shaft portion is connected, having a second surface to which a tab of the electrode assembly extending toward the lid plate is connected, wherein a size of the conductive plate portion and a size of the tab in a planar direction of the lid plate may be set larger than a size of the external terminal.

With the above-mentioned configuration, the conductive plate portion is formed in a plate shape extending substantially parallel to the lid plate and hence, a volume which the conductive plate portion occupies in the outer case is small. Accordingly, volume occupancy of the electrode assembly in the outer case can be increased so that energy density of the energy storage device can be enhanced. In spite of the fact that a volume which the conductive plate portion occupies in the outer case is small, the second surface of the conductive plate portion to which the tab is connected can ensure a large area. Accordingly, a contact area between the tab and the conductive plate portion can be increased so that a resistance loss in the current path in the energy storage device can be reduced. That is, it is possible to provide a current path which is minimally fused even when a large current flows through the current path.

The external terminal is formed using aluminum, and the conductive shaft portion and the metal plate are formed using copper.

In a case where one end of the copper-made conductive shaft portion is swaged to the aluminum-made external terminal, since hardness of aluminum is smaller than hardness of copper, the external terminal is liable to be deformed.

With the above-mentioned configuration, the end portion of the copper-made conductive shaft portion is swaged to the external terminal through the copper-made metal plate and hence, the external terminal is minimally deformed.

Ionization tendency of a surface of the metal plate which is brought into contact with the external terminal is larger than ionization tendency of the metal plate and is smaller than ionization tendency of the external terminal.

At a contact portion between the metal plate and the external terminal, different kinds of metals are brought into contact with each other. Accordingly, assuming a case where a liquid such as water, for example, intrudes into the contact portion so that the metal plate and the external terminal become conductive with each other through the liquid, there is a concern that a galvanic action (galvanic corrosion) occurs. When ionization tendency of the external terminal is larger than ionization tendency of the metal plate, the external terminal corrodes.

When the metal plate is interposed between the external terminal and the conductive shaft portion and ionization tendency is increased in the order of the external terminal, a surface of the metal plate which is brought into contact with the external terminal, and the metal plate body, a potential difference between the surface of the metal plate and the external terminal becomes smaller than a potential difference between the metal plate body and the external terminal. Accordingly, the occurrence of galvanic action can be suppressed and hence, lowering of an electrical performance and shortening of a lifetime can be suppressed.

In the above-mentioned energy storage device, the metal plate may have a plating layer on a surface thereof which is brought into contact with the external terminal.

Since the metal plate has the plating layer on the surface thereof and hence, the deformation of the external terminal can be suppressed, and a galvanic action can be suppressed with the simple configuration.

In the above-mentioned energy storage device, the external terminal may have a first surface on which a recessed portion is formed and a second surface which opposedly faces the outer case, and the metal plate may be disposed in an inside of the recessed portion.

With such a configuration, the swaged portion can be accommodated in the inside of the recessed portion and hence, a conductive member such as a bus bar can be easily connected to the external terminal.

A method of manufacturing an energy storage device including the steps of disposing an external terminal having a second through hole on an outer surface of a lid plate having a first through hole; disposing a metal plate having a third through hole on the external terminal; inserting a conductive shaft portion into the first, the second and the third through holes; and swaging a distal end of the conductive shaft portion such that the metal plate is disposed between the external terminal and a swaged portion in an axial direction of the conductive shaft portion.

With such a configuration, the metal plate is interposed between the distal end of the conductive shaft portion and the external terminal and hence, when the distal end of the conductive shaft portion is swaged to the external terminal, a pressing force generated by swaging is dispersed through the metal plate. Since the deformation of the external terminal is suppressed and swaging can be performed with a strong force, it is possible to acquire favorable mechanical and electrical connecting properties between the swaged portion and the external terminal.

### First Embodiment

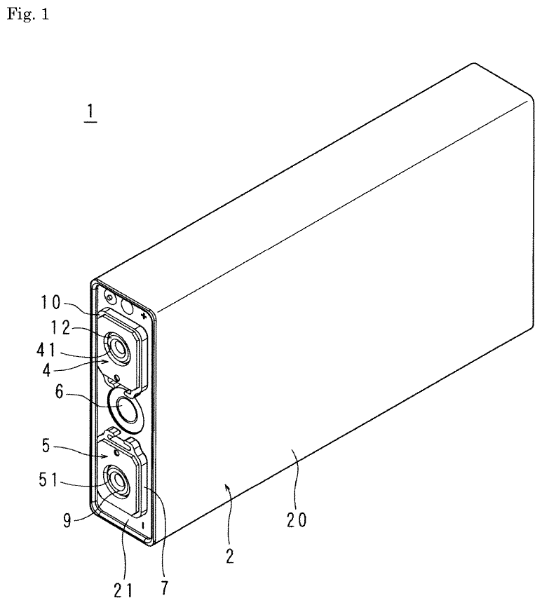

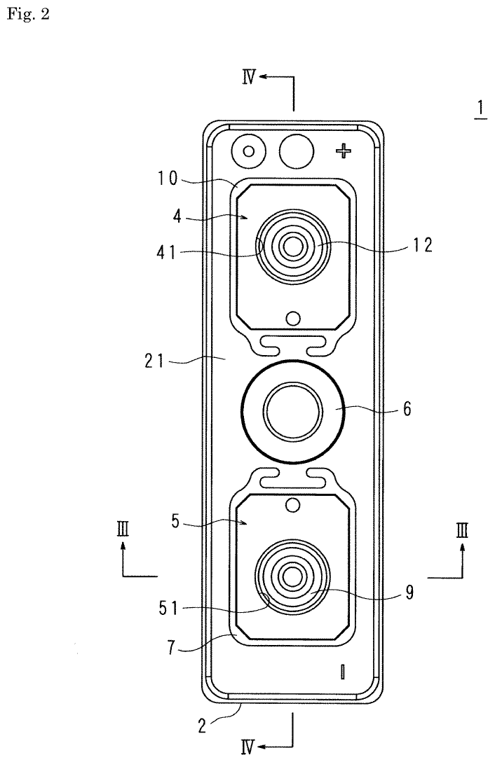

Hereinafter, the present invention is described with reference to drawings showing an energy storage device according to an embodiment. FIG. 1 is a perspective view of the energy storage device according to the first embodiment, and FIG. 2 is a front view of the energy storage device. Hereinafter, the description is made with respect to a case where the energy storage device 1 is a lithium ion secondary battery. However, the energy storage device 1 is not limited to a lithium ion secondary battery.

As shown in FIG. 1, the energy storage device 1 includes: a case 2 having a lid plate 21 and a case body 20; a positive electrode terminal 4; a negative electrode terminal 5; outer gaskets 7, 10; a rupture valve 6, and current collectors 9, 12. The positive electrode terminal 4 has a recessed portion 41 at an approximately center portion thereof, and an end portion of the current collector 12 is mechanically and electrically connected to the recessed portion 41. The negative electrode terminal 5 has a recessed portion 51 at an approximately center portion thereof, and an end portion of the current collector 9 is mechanically and electrically connected to the recessed portion 51. The detailed connection structure of the current collectors 9, 12 is described later.

The case 2 is, for example, made of metal such as aluminum, an aluminum alloy, stainless steel or a synthetic resin. The case 2 has a rectangular parallelepiped shape, and accommodates the electrode assembly 3 described later, and an electrolyte solution (not shown in the drawing). In this embodiment, the lid plate 21 is disposed on a mounting surface of the energy storage device 1 (not shown in the drawing) in a vertically extending manner. The lid plate 21 may be disposed in an upwardly facing manner in FIG. 1.

As shown in FIG. 2, the positive electrode terminal 4 is disposed on one end portion of an outer surface of the lid plate 21 by way of the outer gasket 10, and the negative electrode terminal 5 is disposed on the other end portion of the outer surface of the lid plate 21 by way of the outer gasket 7. The positive electrode terminal 4 and the negative electrode terminal 5 are respectively configured such that a flat outer surface of the electrode terminal is exposed, and a conductive member such as a bus bar (not shown in the drawing) is welded to the outer surface. The rupture valve 6 is disposed between the positive electrode terminal 4 and the negative electrode terminal 5 formed on the lid plate 21.

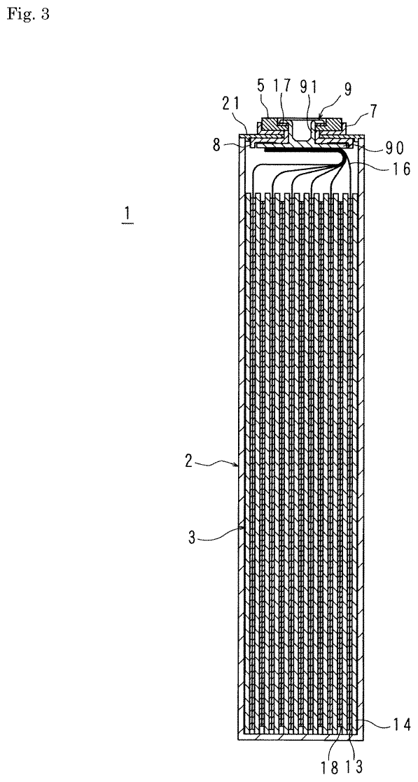

FIG. 3 is a cross-sectional view taken along line III-III in FIG. 2. As shown in FIG. 3, the electrode assembly 3 includes a plurality of positive electrode plates 18, a plurality of negative electrode plates 13, and a plurality of separators 14. The positive electrode plate 18, the negative electrode plate 13, and the separator 14 respectively have a rectangular shape as viewed in a lateral direction in FIG. 3. The plurality of positive electrode plates 18 and the plurality of negative electrode plates 13 are stacked such that the positive electrode plate 18 and the negative electrode plate 13 are alternately stacked with the separator 14 interposed between the positive electrode plate 18 and the negative electrode plate 13. FIG. 3 shows a state where negative electrode tabs 16 respectively extending from the negative electrode plates 13 are made to overlap with each other on a distal end side of the negative electrode plates 13, and are joined to an inner surface (second surface) of a conductive plate portion 90. The negative electrode tabs 16 are accommodated in the inside of the case 2 in a bent posture so as to enhance energy density of the energy storage device 1 (so as to make a space occupied by a current path between the negative electrode terminal 5 and the negative electrode plates 13 small). Although not shown in the drawing, positive electrode tabs 15 (described later) extending from the positive electrode plates 18 have the same configuration as the negative electrode tabs 16.

The electrode assembly 3 may be a winding type electrode assembly obtained by winding an elongated positive electrode plate 18 and an elongated negative electrode plate 13 with a separator 14 interposed between the positive electrode plate 18 and the negative electrode plate 13 in a flat shape.

The mounting structure of the current collector 9 is described later.

The positive electrode plate 18 is obtained by forming a positive active material layer on both surfaces of a positive electrode substrate foil which is a plate-like (sheet-like) or an elongated strip-shaped metal foil made of aluminum, an aluminum alloy or the like. The negative electrode plate 13 is obtained by forming a negative active material layer on both surfaces of a negative electrode substrate foil which is a plate-like (sheet-like) or elongated strip-shaped metal foil made of copper, a copper alloy or the like.

As a positive active material used for forming the positive active material layer or as a negative active material used for forming the negative active material layer, a known material can be used provided that the positive active material and the negative active material can occlude and discharge lithium ions.

As the positive active material, for example, a polyanion compound such as LiMPO₄, LiM₂SiO₄, LiMBO₃ (M being one kind or two or more kinds of transition metal elements selected from a group consisting of Fe, Ni, Mn, Co and the like), a spinel compound such as lithium titanate or lithium manganate, lithium transition metal oxide such as LiMO₂ (M being one kind or two or more kinds of transition metal elements selected from a group consisting of Fe, Ni, Mn, Co and the like) or the like can be used.

As the negative active material, for example, besides lithium metal and a lithium alloy (lithium-aluminum, lithium-silicon, lithium-lead, lithium-tin, lithium-aluminum-tin, lithium-gallium, and a lithium metal containing alloy such as a wood alloy), an alloy which can occlude or discharge lithium ions, a carbon material (for example, graphite, hardly graphitizable carbon, easily graphitizable carbon, low-temperature sintered carbon, amorphous carbon or the like), metal oxide, lithium metal oxide (Li₄Ti₅O₁₂ or the like), a polyphosphoric acid compound and the like can be named.

The separator 14 is formed using a sheet-like or a film-like material into which an electrolyte solution infiltrates. As a material for forming the separator 14, for example, a woven fabric, a non-woven fabric, and a sheet-like or film-like microporous resin can be named. The separator 14 separates the positive electrode plate 18 and the negative electrode plate 13 from each other and, at the same time, holds an electrolyte solution between the positive electrode plate 18 and the negative electrode plate 13.

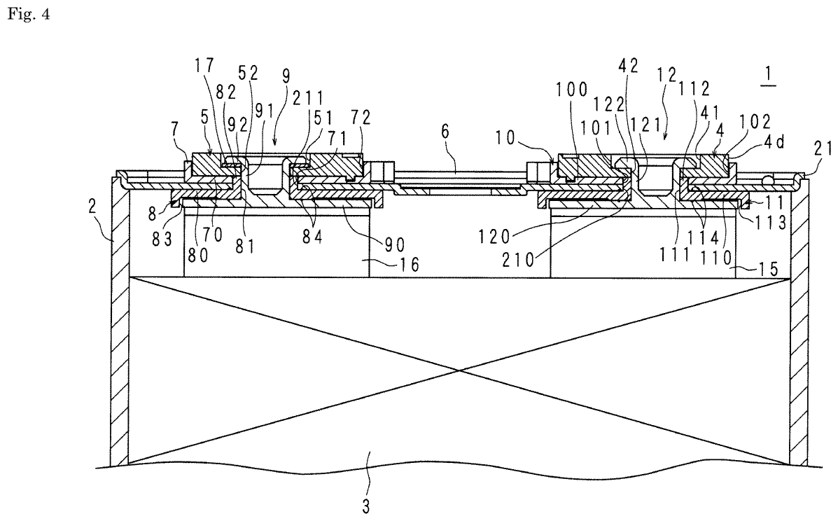

FIG. 4 is a partially enlarged cross-sectional view taken along line IV-IV in FIG. 2. Two through holes 210, 211 are formed in the lid plate 21 in a spaced apart manner in a longitudinal direction of the lid plate 21. The rupture valve 6 is disposed between the through holes 210, 211.

As shown in FIG. 4, the energy storage device 1 includes the negative electrode terminal 5, the outer gasket 7, an inner gasket 8, the current collector 9, and a washer 17 in the vicinity of the through hole 211.

The current collector 9 is made of copper, and includes the conductive plate portion 90, a conductive shaft portion 91, and a swaged portion 92. The conductive plate portion 90 is disposed inside the lid plate 21. The cylindrical conductive shaft portion 91 is disposed at an approximately center portion of an outer surface (first surface) of the conductive plate portion 90, and passes through the through hole 211. The swaged portion 92 is formed on one end of the conductive shaft portion 91 in an axial direction of the conductive shaft portion 91.

The conductive shaft portion 91 may be integrally formed with the conductive plate portion 90. Alternatively, the conductive shaft portion 91 may be formed as a body separate from the conductive plate portion 90 and may be joined to the conductive plate portion 90 by welding, swaging or the like. The conductive shaft portion 91 may be a solid portion.

The inner gasket 8 is made of a synthetic resin such as polyphenylene sulfide (PPS) or polypropylene (PP), for example. The inner gasket 8 has a plate portion 80, an insertion hole 81, a boss 82, an edge portion 83, and compressed convex portions 84. The plate portion 80 is interposed between the conductive plate portion 90 and an inner surface of the lid plate 21, and has the insertion hole 81 at an approximately center portion thereof. The cylindrical boss 82 is disposed so as to surround the insertion hole 81, and covers an outer periphery of the conductive shaft portion 91. On an edge of an inner surface of the plate portion 80, the edge portion 83 which protrudes inward is formed. The edge portion 83 covers a side surface of the conductive plate portion 90. On both surfaces of the plate portion 80 on an outer peripheral side of the boss 82, the ring-shaped compressed convex portion 84 is formed respectively. The compressed convex portion 84 is not limited to a ring shape, and a plurality of compressed convex portions 84 may be formed in a spaced apart manner in a circumferential direction.

The negative electrode terminal 5 is made of aluminum, and has a rectangular plate shape. The negative electrode terminal 5 has a circular-hole-shaped recessed portion 51 on a first surface (outer surface) thereof. In a center portion of a bottom surface of the recessed portion 51, an insertion hole 52 into which the conductive shaft portion 91 is inserted is formed.

On a bottom surface of the recessed portion 51, the washer 17 which forms a metal plate according to this embodiment is placed. The washer 17 is made of copper. By swaging an end portion of the conductive shaft portion 91 to the washer 17, the swaged portion 92 is formed so that the current collector 9 is mechanically and electrically connected to the negative electrode terminal 5. The metal plate is not limited to a washer. For example, the metal plate may be formed by forming a circular hole into which the conductive shaft portion 91 is inserted in a metal-made rectangular plate.

A material for forming the metal plate is not limited to copper. It is sufficient for a material for forming the metal plate to be harder than aluminum which is a material for forming the negative electrode terminal 5. As a material for forming the metal plate, steel, SUS, brass, aluminum which is made harder than aluminum for forming the negative electrode terminal 5 by thermal refining may be named.

The outer gasket 7 is made of a synthetic resin such as PPS or PP. The outer gasket 7 has a plate portion 70, an insertion hole 71, and an edge portion 72. The plate portion 70 is interposed between an outer surface of the lid plate 21 and an inner surface of the negative electrode terminal 5. The insertion hole 71 is formed at an approximately center portion of the plate portion 70, and the boss 82 is inserted into the insertion hole 71. On a peripheral edge of an outer surface of the plate portion 70, the edge portion 72 which protrudes outward is formed. The edge portion 72 covers a side surface of the negative electrode terminal 5.

Respective sizes of the conductive plate portion 90 and the negative electrode tabs 16 in a planar direction (longitudinal direction) of the lid plate 21 are set larger than a size of the negative electrode terminal 5 in a planar direction (longitudinal direction) of the lid plate 21.

As shown in FIG. 4, the energy storage device 1 includes the positive electrode terminal 4, the outer gasket 10, an inner gasket 11, and the current collector 12 in the vicinity of the through hole 210.

The current collector 12 is made of aluminum, and includes a conductive plate portion 120, a conductive shaft portion 121, and a swaged portion 122. The conductive plate portion 120 is disposed inside the lid plate 21. The cylindrical conductive shaft portion 121 is disposed at an approximately center portion of the conductive plate portion 120, and passes through the through hole 210. The swaged portion 122 is formed on an end portion of the conductive shaft portion 121.

The conductive shaft portion 121 may be integrally formed with the conductive plate portion 120. Alternatively, the conductive shaft portion 121 may be formed as a body separate from the conductive plate portion 120 and may be joined to the conductive plate portion 120 by welding, swaging or the like.

The inner gasket 11 is made of a synthetic resin such as PPS or PP, for example. The inner gasket 11 has a plate portion 110, an insertion hole 111, a boss 112, an edge portion 113, and compressed convex portions 114. The plate portion 110 is interposed between the conductive plate portion 120 and the inner surface of the lid plate 21, and has the insertion hole 111 at an approximately center portion thereof. The cylindrical boss 112 is disposed so as to surround the insertion hole 111, and covers an outer periphery of the conductive shaft portion 121. On a peripheral edge of an inner surface of the plate portion 110, the edge portion 113 which protrudes inward is formed. On both surfaces of the plate portion 110 on an outer peripheral side of the boss 112, the ring-shaped compressed convex portion 114 is formed respectively. The compressed convex portion 114 is not limited to a ring shape, and a plurality of compressed convex portions 114 may be formed in a spaced apart manner in a circumferential direction.

The positive electrode terminal 4 is made of aluminum, and has a rectangular plate shape. The positive electrode terminal 4 has the circular-hole-shaped recessed portion 41 on a first surface (outer surface) thereof. In a center portion of a bottom surface of the recessed portion 41, an insertion hole 42 into which the conductive shaft portion 121 is inserted is formed.

Unlike the negative electrode terminal 5, on a bottom surface of the recessed portion 41, the washer 17 is not placed. By swaging an end portion of the conductive shaft portion 121 to the recessed portion 41, the swaged portion 122 is formed so that the current collector 12 is mechanically and electrically connected to the positive electrode terminal 4.

The outer gasket 10 is made of a synthetic resin such as PPS or PP. The outer gasket 10 has a plate portion 100, an insertion hole 101, and an edge portion 102. The plate portion 100 is interposed between the outer surface of the lid plate 21 and an inner surface of the positive electrode terminal 4. The insertion hole 101 is formed at an approximately center portion of the plate portion 100, and the boss 112 is inserted into the insertion hole 101. On a peripheral edge of an outer surface of the plate portion 100, the edge portion 102 which protrudes outward is formed. The edge portion 102 covers a side surface of the positive electrode terminal 4.

Hereinafter, a method of manufacturing the energy storage device 1 is described.

The inner gasket 8 is mounted in the inside of the through hole 211 of the lid plate 21 (the boss 82 being inserted into the through hole 211). The outer gasket 7 is disposed outside the lid plate 21, and a distal end of the boss 82 is inserted into the insertion hole 71.

The negative electrode terminal 5 is disposed in the inside of the edge portion 72, and the insertion hole 52 and the boss 82 are disposed coaxially.

The current collector 9 is disposed in the inside of the inner gasket 8. The conductive shaft portion 91 is inserted into the boss 82, and a distal end portion of the conductive shaft portion 91 protrudes to the outside from the insertion hole 52. The conductive plate portion 90 is disposed inside the edge portion 83.

The washer 17 is fitted on the distal end portion of the conductive shaft portion 91, and is placed on the bottom surface of the recessed portion 51.

The distal end portion of the conductive shaft portion 91 is pressed toward the washer 17 (expanded by pressing) so that the swaged portion 92 is formed. The swaged portion 92 is expanded in the inside of the recessed portion 51 so that the negative electrode terminal 5 is fixed to the outer gasket 7. At this stage of the operation, the compressed convex portions 84, 84 are compressed by pressing by a compression force.

Also with respect to the positive electrode terminal 4, in the same manner as the negative electrode terminal 5, the boss 112 of the inner gasket 11 is inserted into the through hole 210 from the inside of the lid plate 21. The outer gasket 10 is disposed outside the lid plate 21, and the distal end of the boss 112 is inserted into the insertion hole 101. The positive electrode terminal 4 is disposed in the inside of the edge portion 102 so that the insertion hole 42 and the boss 112 are disposed coaxially.

The conductive shaft portion 121 of the current collector 12 is inserted into the boss 112 from the inside of the lid plate 21, the distal end portion of the conductive shaft portion 121 is pressed toward the bottom surface of the recessed portion 41 of the positive electrode terminal 4 so that the swaged portion 122 is formed. The swaged portion 122 expands in the inside of the recessed portion 41 so that the positive electrode terminal 4 is fixed to the outer gasket 10.

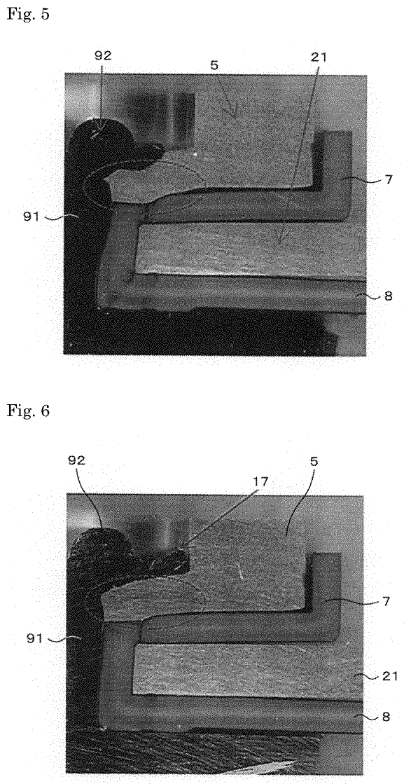

FIG. 5 is a microscope photograph showing a cross section of the swaged portion 92 in a state where the swaged portion 92 is formed by swaging the conductive shaft portion 91 to the negative electrode terminal 5 without placing the washer 17 on the bottom surface of the recessed portion 51.

As shown in FIG. 5, a pressing force is concentrated to a portion of the bottom surface of the recessed portion 51 of the negative electrode terminal 5 so that the portion is recessed and a surface on a side opposite to the portion protrudes. The conductive shaft portion 91 is made of copper, and the negative electrode terminal 5 is made of aluminum. Since hardness of aluminum is smaller than hardness of copper, a downward pressing force is liable to be concentrated on a portion.

In swaging the distal end portion of the conductive shaft portion 121 to the bottom surface of the recessed portion 41 of the positive electrode terminal 4, both the conductive shaft portion 121 and the positive electrode terminal 4 are made of aluminum and hence, a pressing force is dispersed so that the positive electrode terminal 4 is not deformed.

FIG. 6 is a microscope photograph showing a cross section of the swaged portion 92 in a state where the swaged portion 92 is formed by swaging the conductive shaft portion 91 to the negative electrode terminal 5 in a state where the washer 17 is placed on the bottom surface of the recessed portion 51.

It is confirmed that, since the copper-made washer 17 is placed on the bottom surface of the recessed portion 51, a downward pressing force is dispersed by way of the washer 17 at the time of swaging so that, as shown in FIG. 6, deformation of the negative electrode terminal 5 is suppressed.

In this embodiment, the negative electrode tabs 16 are disposed just below the conductive shaft portion 91 and hence, a current path from the negative electrode tabs 16 to the negative electrode terminal 5 is short. The conductive plate portion 90 is formed in a plate shape extending substantially parallel to the lid plate 21 and hence, a volume which the conductive plate portion 90 occupies in the case 2 is small. Accordingly, volume occupancy of the electrode assembly 3 in the case 2 is large and hence, energy density of the energy storage device 1 can be enhanced. In spite of the fact that a volume which the conductive plate portion 90 occupies in the case 2 is small, the inner surface of the conductive plate portion 90 to which the negative electrode tabs 16 are connected can ensure a large area. Accordingly, a contact area between the negative electrode tabs 16 and the conductive plate portion 90 can be increased so that a resistance loss in the current path can be reduced. In the same manner, a current path from the positive electrode tabs 15 to the positive electrode terminal 4 is short, and a contact area between the positive electrode tabs 15 and the conductive plate portion 120 can be increased so that a resistance loss of the current path can be reduced. Accordingly, even when a large current flows in the energy storage device 1, the current path is minimally fused.

As has been described above, the deformation of the negative electrode terminal 5 is suppressed by the washer 17 and hence, swaging force can be increased whereby the swaged portion 92 and the negative electrode terminal 5 can be connected to each other with favorable mechanical and electrical connecting property. The swaged portion 92, the negative electrode terminal 5, the outer gasket 7, the lid plate 21, the inner gasket 8, and the conductive plate portion 90 are favorably integrated with each other and hence, the energy storage device 1 has favorable gas-tightness, and favorable property of preventing a leakage of a liquid from the energy storage device 1 and intrusion of moisture into the energy storage device 1.

### Second Embodiment

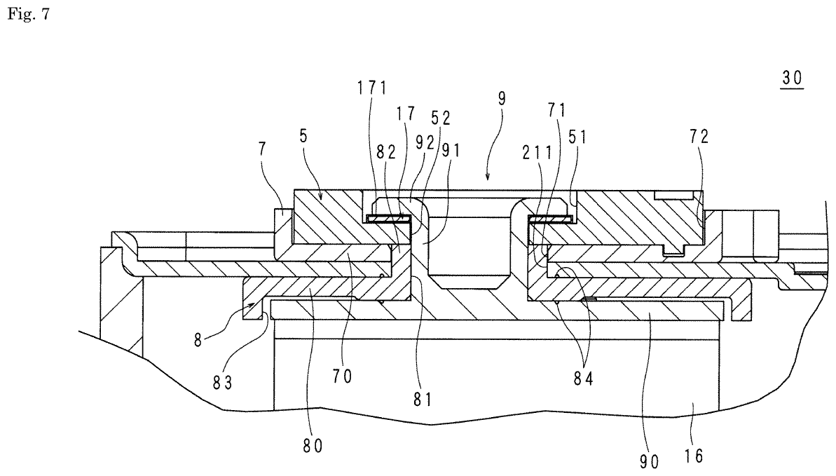

FIG. 7 is a cross-sectional view showing a mounting portion of a lid plate 21 of a negative electrode terminal 5 of an energy storage device 30 according to the second embodiment. In FIG. 7, parts identical with the parts shown in FIG. 4 are given the same symbols, and the detailed description of these parts is omitted.

The energy storage device 30 according to the second embodiment has substantially the same configuration as the energy storage device 1 of the first embodiment except for a point that the energy storage device 30 has a plating layer 171 which is formed on the whole surface of a washer 17 by Ni plating.

The plating layer 171 is formed by Ni plating. Ni plating may be either one of electrolytic Ni plating or electroless Ni plating.

The washer 17 is made of copper, and the negative electrode terminal 5 is made of aluminum. Different kinds of metals are brought into contact with each other at a contact portion between the washer 17 and the negative electrode terminal 5. Accordingly, when an electric current flows in a state where a liquid such as water, for example, intrudes into the contact portion, there is a concern that an electrolytic corrosion phenomenon occurs. Since ionization tendency of aluminum is larger than ionization tendency of copper, the negative electrode terminal 5 corrodes.

When the connecting portion between the negative electrode terminal 5 and the current collector 9 corrodes, electric performance of the energy storage device 1 is lowered so that lifetime of the energy storage device 1 is shortened.

In this embodiment, the plating layer 171 is formed on the surface of the washer 17, and the plating layer 171 is interposed between the washer 17 and the negative electrode terminal 5. The plating layer 171 is made of Ni, and ionization tendency of Ni falls between ionization tendency of aluminum and ionization tendency of copper and hence, a potential difference between the plating layer 171 and the negative electrode terminal 5 becomes smaller than a potential difference between the washer 17 and the negative electrode terminal 5. Accordingly, corrosion resistance can be enhanced.

In this embodiment, the description is made with respect to the case where the plating layer 171 is formed on the whole surface of the washer 17. However, the present invention is not limited to such a case, and it is sufficient that the plating layer 171 be formed on at least a portion of the washer 17 which is brought into contact with the negative electrode terminal 5. In a case where a swaged portion 92 and the washer 17 are made of copper, and the plating layer 171 is not interposed between the swaged portion 92 and the washer 17, a potential difference between contact metals is zero and hence, electric corrosion does not occur at such a contact portion.

Further, a method of decreasing the difference in ionization tendency is not limited to the formation of plating layer 171. It is sufficient that ionization tendency of the surface of the washer 17 fall between ionization tendency of the negative electrode terminal 5 and ionization tendency of the conductive shaft portion 91.

The present invention is not limited to the contents of the embodiments described above, and various modifications are conceivable within the scope of the claims. Embodiments obtained by combining technical features suitably modified within the scope of the claims are also included in the technical scope of the present invention.

In the first embodiment and the second embodiment, the description has been made with respect to the case where the energy storage device 1 is a lithium ion secondary battery. However, the energy storage device 1 is not limited to the lithium ion secondary battery. The energy storage device 1 may be other secondary batteries such as a nickel hydrogen battery, may be a primary battery, or may be an electrochemical cell such as a capacitor.

### DESCRIPTION OF REFERENCE SIGNS

1, 30: energy storage device
2: case
20: case body
21: lid plate
3: electrode assembly
4: positive electrode terminal
41, 51: recessed portion
42, 52: insertion hole
5: negative electrode terminal
6: rupture valve
7, 10: outer gasket
70, 100: plate portion
71, 101: insertion hole
72, 102: edge portion
8, 11: inner gasket
80, 110: plate portion
81, 111: insertion hole
82, 112: boss
83, 113: edge portion
84, 114: compressed convex portion
9, 12: current collector
90, 120: conductive plate portion
91, 121: conductive shaft portion
92, 122: swaged portion
17: washer
171: plating layer

1. An energy storage device comprising:
an outer case on which an external terminal is mounted;
an electrode assembly housed in the outer case;
a conductive shaft portion formed using a material different from a material for forming the external terminal, and having a swaged portion connected to the external terminal on one end thereof in an axial direction;
a conductive plate portion housed in the outer case, to which the other end of the conductive shaft portion is connected, and the electrode assembly is connected; and
a metal plate disposed between the external terminal and the swaged portion in the axial direction of the conductive shaft portion.

2. The energy storage device according to claim 1, wherein the conductive plate portion is formed in a plate shape extending substantially parallel to a lid plate of the outer case, has a first surface to which the other end of the conductive shaft portion is connected, has a second surface to which a tab of the electrode assembly extending toward the lid plate is connected, wherein a size of the conductive plate portion and a size of the tab in a planar direction of the lid plate are set larger than a size of the external terminal in the planar direction of the lid plate.

3. The energy storage device according to claim 1, wherein
the external terminal is formed using aluminum, and
the conductive shaft portion and the metal plate are formed using copper.

4. The energy storage device according to claim 1, wherein ionization tendency of a surface of the metal plate which is brought into contact with the external terminal is larger than ionization tendency of the metal plate and is smaller than ionization tendency of the external terminal.

5. The energy storage device according to claim 1, wherein the metal plate has a plating layer on a surface thereof which is brought into contact with the external terminal.

6. The energy storage device according to claim 1, wherein
the external terminal has a first surface on which a recessed portion is formed and a second surface which opposedly faces the outer case, and
the metal plate is disposed in an inside of the recessed portion.

7. A method of manufacturing an energy storage device, the method comprising:
disposing an external terminal having a second through hole on an outer surface of a lid plate having a first through hole;
disposing a metal plate having a third through hole on the external terminal;
inserting a conductive shaft portion into the first, the second, and the third through holes; and
swaging a distal end of the conductive shaft portion such that the metal plate is disposed between the external terminal and a swaged portion in an axial direction of the conductive shaft portion.
